(19) United States
(12) Patent Application Publication
(10) Pub. No.: US 2007/0248111 A1
(43) Pub. Date: Oct. 25, 2007

(54) System and method for clearing information in a stalled output queue of a crossbar

(76) Inventors: Mark E. Shaw, Garland, TX (US); Leon Hong, Austin, TX (US); Gary B. Gostin, Plano, TX (US); Vipul Gandhi, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/409,649

(22) Filed: Apr. 24, 2006

(51) Int. Cl. H04L 12/56

(52) U.S. Cl. 370/412; 370/465

(57) ABSTRACT

Various embodiments of a system and method that clears information in a stalled output queue of a crossbar are disclosed. Briefly described, one embodiment is a method comprising communicating a piece of information into an exit queue residing in the output queue, monitoring a time that the piece of information resides in the exit queue, and clearing of the piece of information from the exit queue when the monitored time exceeds a predefined time.

### TECHNICAL FIELD

The embodiments are generally related to computer systems and, more particularly, are related to a system and method for clearing information in a stalled output queue of a crossbar.

### BACKGROUND

Multi-processor systems, such as a symmetric multiprocessing (SMP) system, employ many parallel-operating central processing units (CPUs) which independently perform tasks under the direction of a single operating system. One type of multi-processor system is based upon a plurality of CPUs employing high-bandwidth point-to-point links (rather than a conventional shared-bus architecture) to provide direct connectivity between the CPU and to input/output (I/O) devices, memory units and/or other CPUs.

Smaller groupings of CPUs residing in close proximity to each other may be aggregated onto the same die and/or chip board. Such groupings, or clusters, may be further aggregated into partitions (nPAR). A plurality of nPARs may be configured from a relatively large SMP system. Each nPAR may be tasked to perform unrelated functions or activities.

However, the various nPARs may need to communicate information across the SMP system to other devices, such as input/output (I/O) controllers, other CPUs in the NPAR that are remotely located within the SMP system, or to other CPUs in different nPARs. Thus, communication paths must be established across the SMP system. Such communication paths may be established using crossbars. Typically, many crossbars may be used to provide path redundancy and/or to facilitate modular construction of the SMP system.

Crossbars employ input and output queues for reception and transmission of information. One type of SMP system employs a packet-based communication protocol. Each packet contains source and destination information that identifies the sending device (such as one of the SMP CPUs) and an intended destination device.

As the information arrives at a crossbar, it is stored in an input queue coupled to the connection on which the information arrives on. The crossbar controller system then identifies an output queue in the crossbar that the information is to be sent to. The output queue is coupled to the destination device or to another crossbar (if further routing is required).

It is possible for a destination device to become disabled or to be in an operating mode where the destination device is not able to accept the information from the output queue of the crossbar to which it is communicatively coupled to. Accordingly, the information is held up in that output queue. Since the information in the output queue is stalled, no other information can be communicated out from that output queue. That is, the output queue has become stalled.

In the event that other information, which may be destined for the stalled device or for other devices, is subsequently communicated into the stalled output queue, the subsequent information cannot be communicated out of the queue because of the stall. Furthermore, the stall may propagate through the SMP system when information destined for the stalled device causes stalls on other queues. In such stalling scenarios, operation of other nPARs of the SMP system may be adversely affected. In extreme situations, the entire SMP system may become stalled and might be forced into an uncontrolled system shutdown.

### SUMMARY

Various embodiments are disclosed that clear information in a stalled output queue of a crossbar. One embodiment comprises an output queue that receives at least one piece of information from at least one other timed port residing in the crossbar, an exit queue residing in the output queue and a queue timer coupled to the exit queue that monitors time that the received information piece resides in the exit queue, such that upon expiration of a predefined time, the queue timer causes clearing of the information piece in the exit queue.

Another embodiment is a method comprising communicating a piece of information into an exit queue residing in the output queue, monitoring a time that the piece of information resides in the exit queue, and clearing of the piece of information from the exit queue when the monitored time exceeds a predefined time.

### BRIEF DESCRIPTION OF THE DRAWINGS

The components in the drawings are not necessarily to scale relative to each other. Like reference numerals designate corresponding parts throughout the several views.

FIG. 1 is block diagram of a symmetric multiprocessing (SMP) system employing embodiments of the timed port crossbars.

FIG. 2 is a block diagram illustrating in greater detail an exemplary embodiment of a timed port crossbar.

FIG. 3 is a block diagram illustrating in greater detail an embodiment of a timed port crossbar with four timed ports.

FIGS. 4A and 4B are block diagrams illustrating greater detail of embodiments of a timed port.

FIG. 5 is a block diagram illustrating an embodiment of a timed port crossbar with a queue timer monitoring flow of information through an input queue.

FIG. 6 is a flowchart illustrating a process used by an embodiment of a timed port crossbar.

### DETAILED DESCRIPTION

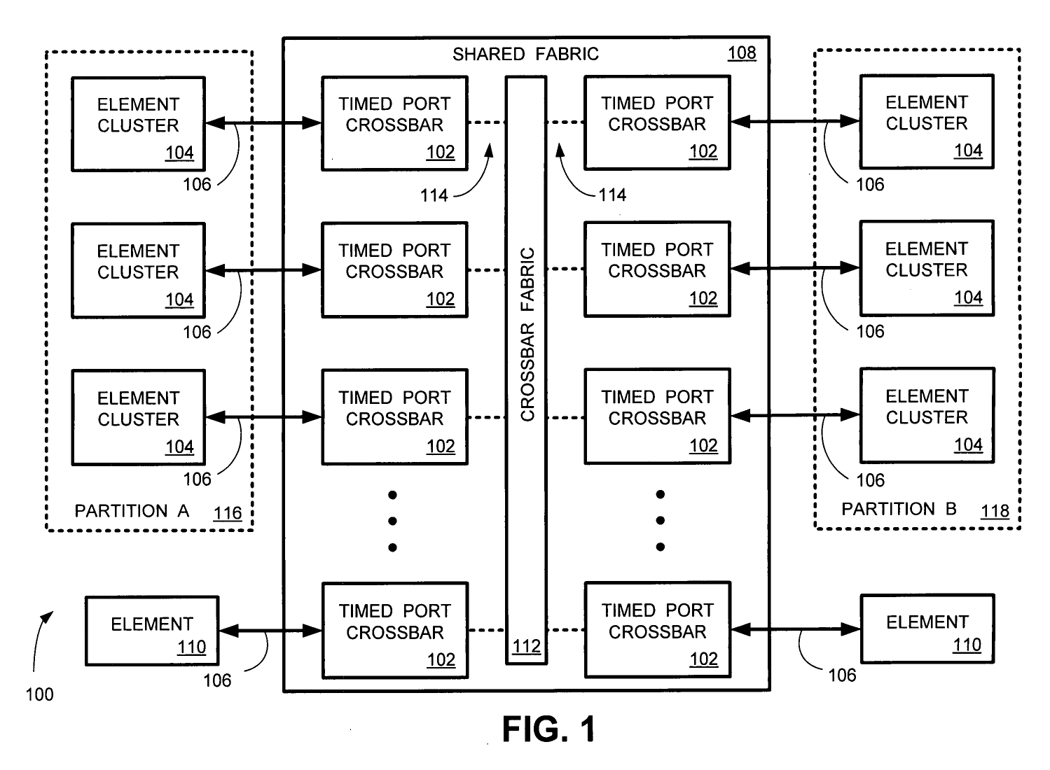

FIG. 1 is block diagram of a symmetric multiprocessing (SMP) system 100 employing embodiments of the timed port crossbars 102. The exemplary SMP system 100 comprises a plurality of element clusters. Clusters are comprised of a plurality of components, as mentioned above, including central processing units (CPUs), directories, input/output (I/O) devices, and/or other devices.

One type of multi-processor system is based upon a plurality of parallel operating CPUs and other devices employing high-bandwidth, point-to-point links 106. The point-to-point links 106 provide connectivity, via the shared fabric 108, between element clusters 104 and/or elements 110 (which may be single elements such as I/O devices, memory units and/or other CPUs). As an illustrative example, one type of high-bandwidth, point-to-point link 106 is a serializer/deserializer (SERDES) link. Each SERDES link employs four high-speed pins, two per direction, to support bi-directional communications.

The shared fabric 108 is comprised of a plurality of timed port crossbars 102 and the crossbar fabric 112. Timed port crossbars 102 are coupled to each other, under various connectivity topologies, via connections 114. In some embodiments, the connections 114 are SERDES links, although any suitable connection form may be used in the various embodiments.

For illustration purposes, the simplified SMP system 100 has been divided into two partitions (nPARs), partition A 116 and partition B 118. As noted above, a plurality of nPARs may be configured from a relatively large SMP system. Each nPAR may be tasked to perform unique functions or activities.

When a CPU or other device needs to communicate information to a remote device, via shared fabric 108, the timed port crossbars 102 to which the devices are coupled provide connectivity between each other via the crossbar fabric 112. In some topologies, crossbars (not shown) may also reside in the crossbar fabric 112 (such crossbars may be embodiments of the timed port crossbars 102 and/or may be conventional crossbars.)

In some topologies, components of two or more element clusters 104 may be coupled together directly via a single timed port crossbar 102. For example, elements in partition A may be coupled to elements of partition B via a single timed port crossbar 102. Or, elements in a first cluster in partition A may be coupled to elements of another cluster in partition A via a single timed port crossbar 102. Furthermore, embodiments of the timed port crossbars 102 may be used for all of the crossbars in the shared fabric 108, or may be limited to selected portions of the shared fabric 108 (with the other portions using conventional crossbars). Accordingly, it is understood that the various possible topologies of an SMP system, with or without nPARs, are nearly limitless and that the SMP system 100 of FIG. 1 is a very simplified block diagram for illustration purposes. All such variations in topology of an SMP system 100 employing embodiments of timed port crossbars 102 are intended to be included within the scope of this disclosure.

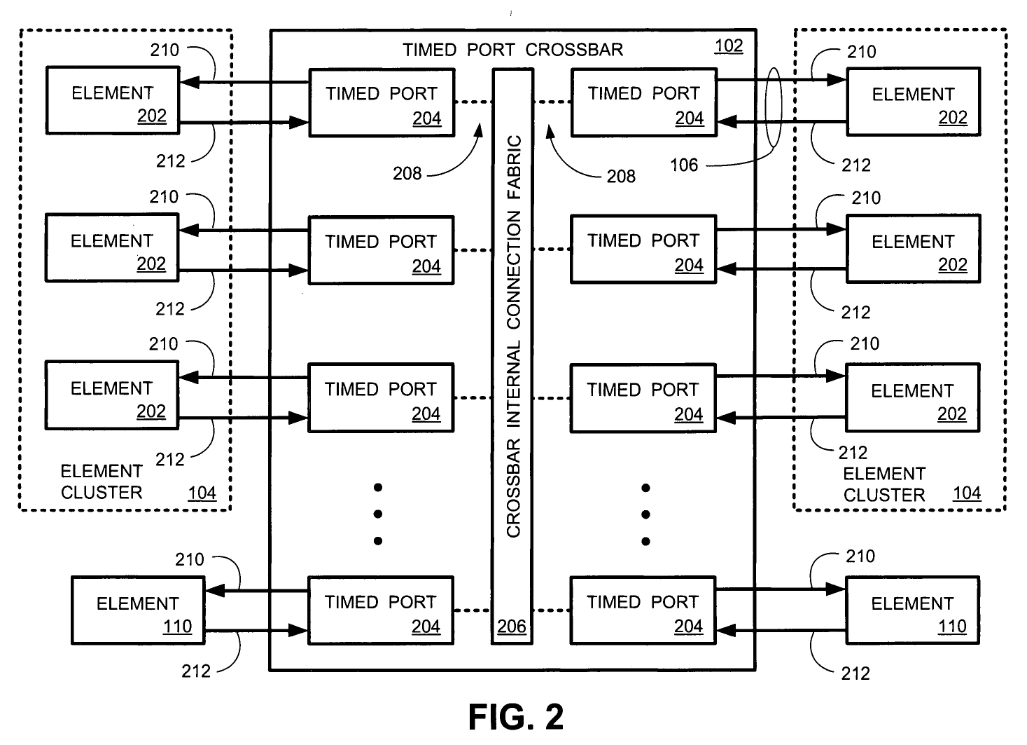

FIG. 2 is a block diagram illustrating in greater detail an exemplary embodiment of a timed port crossbar 102. For illustration purposes, the timed port crossbar 102 is illustrated as providing connectivity between elements 202 of the element clusters 104. As noted above, such elements could be CPUs, directories, I/O devices or other devices. Furthermore, the timed port crossbar 102 could optionally provide connectivity to elements 110 (such as, but not limited to, an I/O device, another timed port crossbar 102, or another crossbar).

The timed port crossbar 102 is comprised of a plurality of timed ports 204, described in greater detail below. Timed ports 204 are coupled to each other via the crossbar internal connection fabric 206, via connections 208. The various types of connections 208 and fabric 206, and the manner in which they are used to provide connectivity between timed ports 204, is understood in the arts and is not described in detail herein. All such topologies and hardware configurations that provide coupling between timed ports 204 are intended to be included within the scope of this disclosure.

In a preferred embodiment, the high speed link 106 is comprised of two communication paths 210 and 212 that provide bi-directional communications into and out of a timed port 204. Path 210 provides for flow of information out of the timed port 204 to the element 202 to which it is coupled. Path 212 provides for flow of information into the timed port 204 from the element 202 to which it is coupled.

For example, but not limited to, in the above-described SERDES link which employs four high-speed pins (two per direction) to support bidirectional communications, path 210 would correspond to two of the pins, and path 212 would correspond to the other two pins.

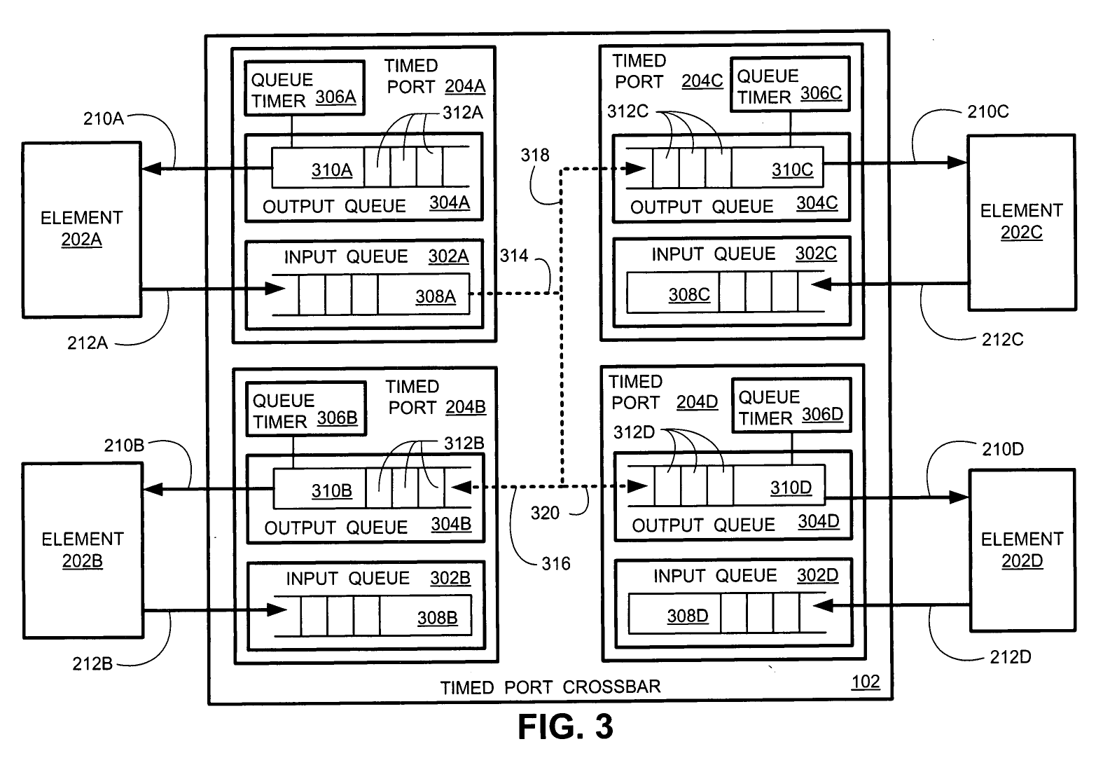

FIG. 3 is a block diagram illustrating in greater detail an embodiment of a timed port crossbar 102 with four timed ports 204 (where the reference letters A-C are used to identify particular locations of the elements within the exemplary timed port crossbar 102). Accordingly, timed port crossbar 102 may be viewed as a four-port crossbar. It is appreciated that alternative embodiments of a timed port crossbar 102 may have more than four timed ports 204.

Each timed port 204 comprises an input queue 302, an output queue 304, and a queue timer 306. Input queues 302 and output queues 304 comprises one or more information queues 308, 312 (four information queues are illustrated for convenience), respectively. Each information queue 308, 312 is configured to store a single piece of information.

In one exemplary embodiment, information queues 308, 312 are serially connected such that a piece of information arrives into first of the information queues 308, 312. Then, the piece of information is serially or sequentially propagated to the last one of the information queues 308, 312, referred to hereinafter as an “exit” queue. When the piece of information resides in exit queue, it can then be communicated onto the output connection coupled to that queue.

In other embodiments, the output queues (and input queues) may be implemented using other memory based medium and architecture. For example, a random access memory (RAM) may store information. The location of the information could be identified by a pointer or other suitable identifier. In another embodiment, a latch array or the like is used.

Input queues 302 and output queues 304 may be implemented using any suitable medium where information may be received, stored and then communicated to another component. For convenience, the output queues 304 have their exit queue identified with reference numeral 310. (In a serial queue embodiment it may be configured similar to the illustration in the FIG. 3. In a RAM or latch embodiment, the exit queue corresponds to the pointer or other suitable identifier indicating the location of the information that is to be next communicated out from the queue.)

For example, element 202A may couple to the timed port 204A, via paths 210A and 212A. Elements 202B, 202C and 202D are similarly coupled to their respective timed ports 204B-D. Assuming that element 202A needs to communicate a piece of information to element 202B, the process of communicating starts with the information piece being communicated over path 212A into the first information queue 308A of the input queue 302A. If there are a plurality of information queues 308A, the information piece is serially shifted or sequentially communicated to the last of the queues 308A (exit queue) so that the information piece is ready to be communicated onto connection 314.

In the various embodiments, the timed port crossbar 102 configures itself to establish a path between the timed port 204A and the timed port 204B, via paths 314 and 316. Once the path is established, the piece of information may be communicated to the first information queue 312B of the output queue 304B. If there are a plurality of information queues 312B, the information piece is serially shifted or sequentially communicated to the exit queue 310B so that the information piece is ready to be communicated onto path 210B. When element 202B is ready to receive the information, the information piece is communicated out of the exit queue 310B onto connection 210B.

Similarly, if element 202A needs to communicate a piece of information to element 202C, the information piece is communicated into the input queue 302A. Then, a path 314, 318 is configured by the timed port crossbar 102 to the output queue 304C. The information piece is then communicated to output queue 304C. When element 202C is ready to accept the information, the information piece is output onto connection 210C from the exit queue 310C. Likewise, if element 202A needs to communicate information to element 202D, the information is communicated via the input queue 302A, a path 314, 320, output queue 304D, and when element 202D is ready to accept the information, the information piece is output onto connection 210D.

Returning to the above-described example with a similar communication of information in a conventional SMP system using conventional crossbars, in some situations, element 202B may not be able to receive the information communicated to it from element 202A. In such situations, with conventional crossbars, the information would be held up, or stalled, in the output queue that is coupled to element 202B for an indefinite period of time. If the element 202B has malfunctioned or otherwise failed, the information may never be communicated out of the output queue (until the system crashes or is otherwise reset). Furthermore, if the information is not output from the queue that is coupled to element 202B, there may be a backup of communications of other information such that other queues of a conventional crossbar become backed up with information waiting their turn to be communicated. That is, the stall may propagate through other input and/or output queues of a conventional crossbar. As other input and/or output queues become stalled (no longer able to receive or communicate information), input and/or output queues of other crossbars may be come affected. Thus, the entire SMP system may become inoperational, and as is referred to in the arts, the SMP system will “crash” in an uncontrolled and undesirable manner.

Embodiments of the timed port crossbars 102 are configured to mitigate the impact of stalled information in an output queue 304. An embodiment of queue timer 306, communicatively coupled to its respective exit queue 310, monitors the time that a piece of information resides in exit queue 310. Upon the expiration of the predefined time period, without the communication of information out of the exit queue 310, the queue timer 306 causes the information stalled in the exit queue 310 to be cleared, wherein clearing refers to information that is discarded, erased or otherwise deleted from the exit queue 310.

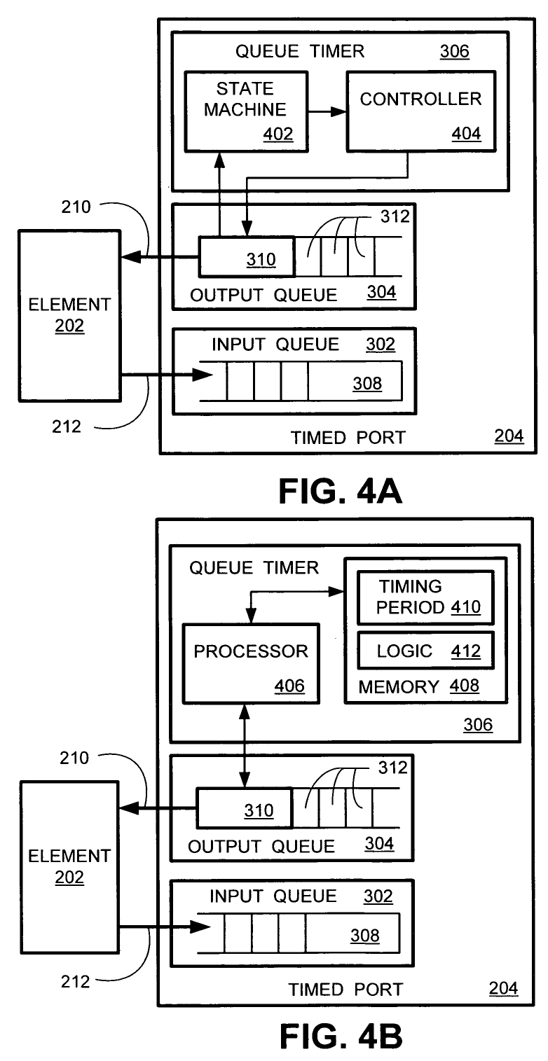

FIG. 4A is a block diagram illustrating greater detail of an embodiment of timed port 204. This exemplary embodiment comprises a state machine 402 and a controller 404. State machine 402 performs the timing operations. State machine starts monitoring time upon arrival of information into the exit queue 310. Such timing may be done in real time, in cycles or in another suitable unit of measure corresponding to time. If the information is communicated out of the exit queue 310 before expiration of the predefined time period, the timing function is reset. However, if the information has not been communicated out of the exit queue 310 by the end of the predefined time period, the state machine 402 communicates a time-out signal to the controller 404. Controller 404 then causes the information in the exit queue 310 to be cleared (the information is discarded, erased or otherwise deleted).

FIG. 4B illustrates an alternative embodiment implemented using a processor 406 and memory 408. Here, processor 406 times the period that the information resides in the exit queue 310, similar to the timing performed by the above-described state machine 402. The timing period 410 has been pre-programmed into a region of memory 408. If the information becomes stalled in the exit queue 310, the logic 412 (which has been retrieved from memory 408 for execution by processor 406) causes the processor to generate a control signal that causes the information in the exit queue 310 to be cleared.

It is appreciated that alternative embodiments of queue timer 306, implemented using a state machine and a controller, or by a processor and a memory, may be configured to monitor and control a plurality of output queues. The exit queue 310 (FIGS. 1-3) time monitoring function and stalled information clearing function may be implemented with other functions performed by the timed port crossbar 102. For example, the exit queue 310 time monitoring function, and/or stalled information clearing function, may be performed by the same components that determine and enable communication paths through the timed port crossbar 102. Furthermore, other embodiments may be implemented using a combination of state controllers, processors, controllers and/or memory.

As noted above, each queue timer 306 is configured to monitor how long of a time that the information has been in its respective exit queue 310. After expiration of a predetermined time period, the queue timer 306 causes the contents of at least the exit queue 310 to be cleared. Thus, if a back-up has occurred in other queues of the timed port crossbar 102, the cleared information allows other information to propagate though the other input and/or output queues.

A simplified hypothetical illustrative example is provided. Assume that input queues 302A-C have four information queues 308 each. That is, there is sufficient storage in each of the input queues 302A-C for four pieces of information. Similarly, assume that output queues 304A-C have four information queues (three information queues 312 and the exit queue 310) so that there is sufficient storage for four pieces of information.

At some point in the hypothetical operating process, assume that element 202A needs to communicate five pieces of information to element 202B, and then communicate one piece of information to element 202C. The first four information pieces are communicated in a serial or sequential fashion from element 202A, through the input queue 302A, and into the output queue 304B. At this point, output queue 304B is full and cannot accept additional information until the first information piece in the exit queue 310B is communicated out to element 202B.

Upon sending the fifth information piece by element 202A, that information piece will be held in the last one of the information queues 308A (an exit queue), awaiting its turn to be communicated to output queue 304B. Then, assume that the piece of information destined for element 202C is communicated into the input queue 302A by element 202A. Because information is communicated through the information queues 308A in a serial or sequential fashion, the information piece destined for element 202C cannot be communicated until after the fifth piece of information (now residing in the exit queue of input queue 302A) is output onto connection 314.

Similar to the above-described example of stalling in a conventional crossbar, assume that element 202B is not able to receive information from the output queue 304B. Accordingly, output queue 304B cannot communicate the first information piece onto connection 210B. That is, the first piece of information is stuck in the exit queue 310B. Since information is not moving through the output queue 304B, the output queue 304B is stalled.

Furthermore, since the fifth information piece, backed up in the input queue 302A, cannot be communicated out to output queue 304B (because it is full), the fifth information piece becomes stalled in the input queue 302A. That is, the input queue 302A also becomes stalled. Accordingly, in this simplified example, the previously communicated first piece of information destined to element 202C cannot be communicated out from the input queue 302A to the output queue 304C.

Once the first piece of information communicated from element 202A (destined for element 202B) arrives at the exit queue 310B, the queue timer 306B begins its timing process. Upon the expiration of the predefined timing period, a determination is made that the first piece of information has not been communicated out of the exit queue 310B. Then, the queue timer 306B causes at least the first information piece to be cleared from the exit queue 310B.

Then, the second piece of information may move into the exit queue 310B. Accordingly, the fifth piece of information, sitting in the input queue 302A, can be communicated to the output queue 304B. After the fifth piece of information has moved out of the input queue 302A, the first piece of information destined to element 202C, in this simplified example, moves into the exit queue position of input queue 302A. Then, this first piece of information destined to element 202C can be communicated to the output queue 304C. That is, the input queue 302A is no longer stalled.

If element 202B is unable to accept information from the output queue 304B, the stalled information may be cyclically cleared such that other information may be communicated to other queues in the timed port crossbar 102. Accordingly, backup or stalling of information flow to other elements is avoided, and operation of the SMP system may be allowed to continue.

In an alternative embodiment, all pieces of information in an output queue 310 are cleared if its respective queue timer 306 times out. Thus, when new information arrives into the exit queue 310, the timing process begins. Such an embodiment may more quickly clear stalls in remote ports.

In another embodiment, another system is configured to monitor the status of the stalled element. As long as the element is not able to receive information from the output queue 304, the timed port 204 continuously clears newly received information coming into the output queue 304 for other timed ports 204. When the stalled element recovers and is able to receive information, then the process of communicating information through the output queue 304 resumes.

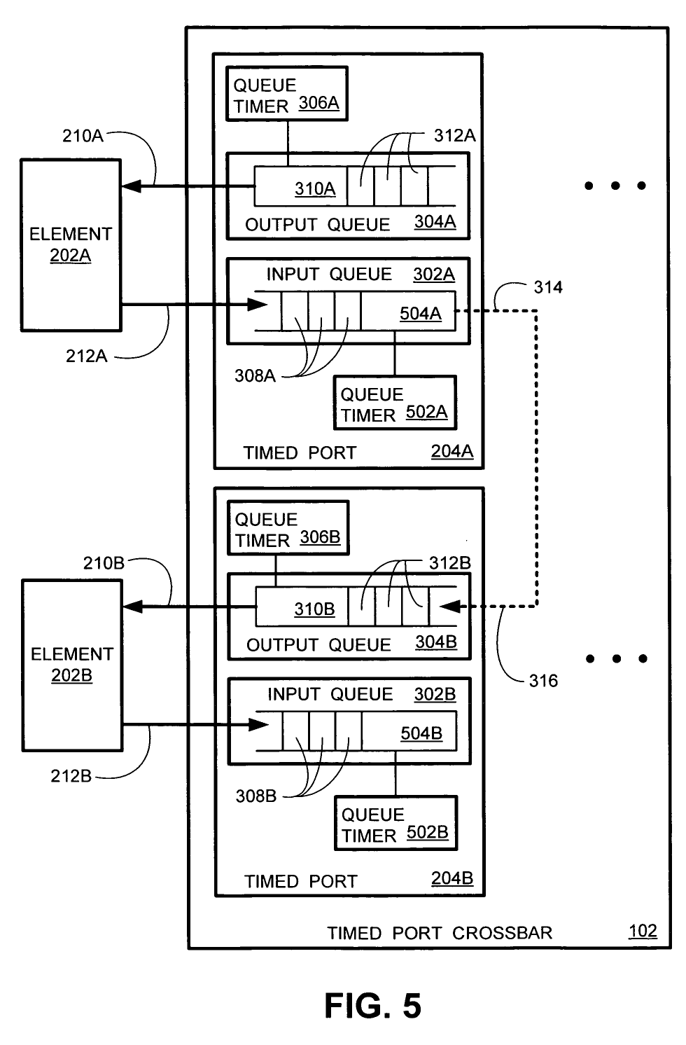

FIG. 5 is a block diagram illustrating an embodiment of a timed port crossbar 102 with a queue timer 502 monitoring flow of information through an input queue 302. Like the above-described queue timer 306, the queue timer 502 is communicatively coupled to its respective exit queue 504, and monitors flow of information into and out of its exit queue 504. Upon the expiration of a second predefined time period, without the communication of information out of the exit queue 504, the queue timer 502 would cause the information stalled in the exit queue 504 to be cleared. With this embodiment, the second time period used by the queue timer 502 is greater than the time period used by the queue timer 306 so that information is not prematurely cleared from the exit queue 504.

As an illustrative example, it may be that a plurality of timed ports 204 are attempting to communicate many information pieces to element 202B (referencing the above-described hypothetical example). Since element 202B is not receiving information from exit queue 310B, and because there are, in this example, many pieces of information queued up in line in the other timed ports 204, the ultimate clearing of all information destined to element 202B may take an undesirably long time to clear in the above-described embodiments having queue timers coupled only to output queues 304. However, the embodiment illustrated in FIG. 5 allows the queue timers 502 to detect the stall on information destined to the stalled element 202B since such information becomes stalled in the input queue 302. Accordingly, after the expiration of the second time period, the information (destined to the stalled element 202B) residing in the exit queue 504 may be cleared.

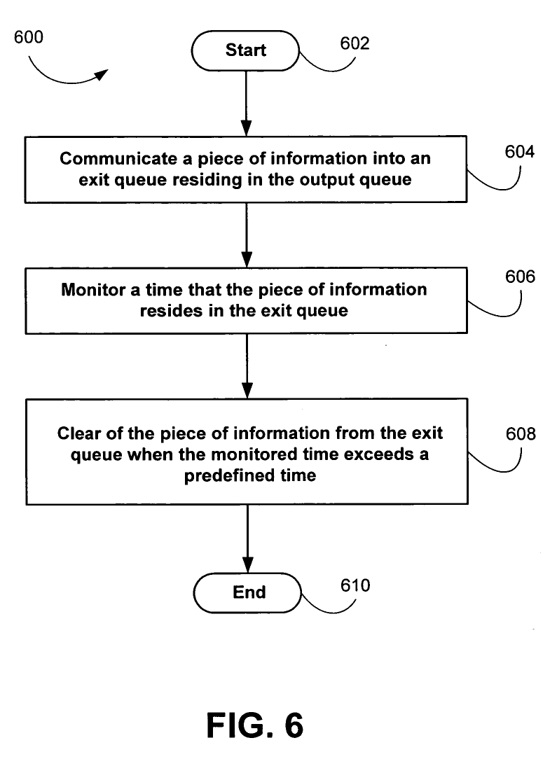

FIG. 6 shows a flow chart 600 illustrating a process used by an embodiment of a timed port crossbar 102 (FIGS. 1-3). The flow chart 600 of FIG. 6 shows the architecture, functionality, and operation of an embodiment for implementing the logic 412 (FIG. 4B). An alternative embodiment implements the logic of flow chart 600 with hardware configured as a state machine, such as illustrated in FIG. 4A. In this regard, each block may represent a module, segment or portion of code, which comprises one or more executable instructions for implementing the specified logical function(s). It should also be noted that in alternative embodiments, the functions noted in the blocks may occur out of the order noted in FIG. 6, or may include additional functions. For example, two blocks shown in succession in FIG. 6 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process begins at block 602. At block 604, a piece of information is communicated into an exit queue residing in the output queue. At block 606, a time that the piece of information resides in the exit queue is monitored. At block 608, the piece of information is cleared from the exit queue when the monitored time exceeds a predefined time. The process ends at block 610.

Embodiments of the timed port crossbar 102 implemented in memory 408 (FIG. 4) may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

It should be emphasized that the above-described embodiments are merely examples of the disclosed system and method. Many variations and modifications may be made to the above-described embodiments. All such modifications and variations are intended to be included herein within the scope of this disclosure.

What is claimed is:

1. A system that that clears information in a stalled output queue of a crossbar, the crossbar comprising a plurality of timed ports, each timed port further comprising:
an output queue that receives at least one piece of information from at least one other timed port residing in the crossbar;
an exit queue residing in the output queue; and
a queue timer coupled to the exit queue that monitors time that the received information piece resides in the exit queue, such that upon expiration of a predefined time, the queue timer causes clearing of the information piece in the exit queue.

2. The system of claim 1, wherein the output queue further comprises at least one information queue coupled to the exit queue such that a plurality of information pieces may reside in the output queue, and such that the information pieces are communicated from the information queue into the exit queue.

3. The system of claim 2, wherein after the information piece residing in the exit queue is cleared in response to the expiration of the predefined time, a next information piece residing in the information queue is communicated into the exit queue, and the queue timer begins to monitor the time that the next information piece resides in the exit queue.

4. The system of claim 2, wherein all of the plurality of information pieces are cleared upon expiration of the predefined time.

5. The system of claim 4, wherein newly received information pieces communicated to the output queue are continuously cleared until an element coupled to the output queue is able to receive the information pieces.

6. The system of claim 1, wherein the queue timer comprises:
a state machine that times the predefined time; and
a controller that causes the information piece to be cleared from the exit queue upon expiration of the predefined time.

7. The system of claim 1, wherein the queue timer comprises:
a processor that times the predefined time and that causes the information piece to be cleared from the exit queue upon expiration of the predefined time; and
a memory coupled to the processor wherein the predefined time is stored.

8. The system of claim 1, further comprising:
an input queue that receives another information piece from an element, the information piece destined for another element coupled to the output queue;
a second exit queue residing in the input queue; and
a second queue timer coupled to the second exit queue that monitors time that the received other information piece resides in the second exit queue, such that upon expiration of a second predefined time, the second queue timer causes clearing of the other information piece in the second exit queue.

9. The system of claim 8, wherein the second predefined time is greater than the predefined time.

10. The system of claim 1, further comprising a symmetric multiprocessing (SMP) system wherein the SMP system comprises at least a plurality of central processing units (CPUs) directories, input/output (I/O) devices and crossbars, and wherein at least one of the crossbars comprises the output queue, the exit queue and the queue timer.

11. A method for clearing information in a stalled output queue of a crossbar, comprising:
communicating a piece of information into an exit queue residing in the output queue;
monitoring a time that the piece of information resides in the exit queue; and
clearing of the piece of information from the exit queue when the monitored time exceeds a predefined time.

12. The method of claim 11, further comprising comparing the monitored time with the predefined time.

13. The method of claim 11, further comprising clearing a plurality of other pieces of information residing in a plurality of corresponding information queues when the monitored time exceeds the predefined time.

14. The method of claim 11, further comprising:
communicating another piece of information into the exit queue after clearing the other piece of information residing in an information queue coupled to the exit queue; and
monitoring the time that the other piece of information resides in the exit queue.

15. The method of claim 14, further comprising clearing the other piece of information from the exit queue when the monitored time exceeds the predefined time.

16. The method of claim 11, wherein the clearing further comprises concurrently clearing a plurality of other pieces of information from a plurality of information queues when the monitored time exceeds the predefined time.

17. The method of claim 11, further comprising
communicating another piece of information into a second exit queue residing in an input queue;
monitoring a second time that the other piece of information resides in the second exit queue; and
clearing of the other piece of information from the second exit queue when the monitored second time exceeds a second predefined time.

18. The method of claim 17, wherein the second predefined time is greater than the predefined time.

19. The method of claim 17, wherein the piece of information and the other piece of information are destined for a first element that has stalled.

20. A system for clearing information in a stalled output queue of a crossbar, comprising:
means for receiving a piece of information from a first element that is destined for a second element;
means for communicating the received piece of information from an input queue in a first timed port into an exit queue residing in the output queue of a second timed port;
means for monitoring a time that the piece of information resides in the exit queue; and
means for clearing of the piece of information from the exit queue when the monitored time exceeds a predefined time.

21. A program for clearing information in a stalled output queue of a crossbar, the program comprising logic configured to perform:
monitoring a time that a piece of information resides in an exit queue, the exit queue residing in the output queue; and
clearing of the piece of information from the exit queue when the monitored time exceeds a predefined time.
